(19) United States
(12) Patent Application Publication
(10) Pub. No.: US 2022/0078307 A1
(43) Pub. Date: Mar. 10, 2022

(54) APPARATUS, METHOD, AND PROGRAM FOR PROCESSING JOB

(71) Applicant: Konica Minolta, Inc., Tokyo (JP)

(72) Inventor: Hikaru MUTO, Itami-shi (JP)

(73) Assignee: Konica Minolta, Inc., Tokyo (JP)

(21) Appl. No.: 17/464,940

(22) Filed: Sep. 2, 2021

(30) Foreign Application Priority Data
Sep. 9, 2020 (JP) 2020-151360

(51) Int. Cl. H04N 1/32; H04L 29/06; H04N 1/44; G06F 3/12

(52) U.S. Cl. CPC H04N 1/32117; H04L 63/0272; G06F 3/1231; G06F 3/1222; H04N 1/4406

(57) ABSTRACT

An apparatus includes: a communicator that communicates with another apparatus; and a controller that processes a job, wherein the apparatus, further, is communicable with a storage that stores device identification information and user identification information in association with each other, and the controller acquires, from the other apparatus, an execution request for a guest user's job including the device identification information, acquires the device identification information from the execution request, accesses the storage to search for the user identification information associated with the device identification information, and processes the guest user's job as a registered user's job on the basis of a fact that the user identification information associated with the device identification information is acquired from the storage.

The entire disclosure of Japanese patent Application No. 2020-151360, filed on Sep. 9, 2020, is incorporated herein by reference in its entirety.

### BACKGROUND

### Technological Field

The present disclosure relates to a technology for processing a job, and ore specifically, to a job type switching technology.

### Description of the Related art

In recent years, there is a service such as cloud print that provides a function of processing a job received from a remote terminal without a driver. By using such a service, for example, jobs not including authentication information can be transmitted from not only the inside of an office but also a personal computer (PC) at home to a multifunction peripheral (MFP) or the like in the office. These jobs can be executed by the NIFP as a guest user's job. For example, it is assumed that a user registered in a certain service forgets to perform an authentication process and transmits a guest user's job to the service. In this case, even if the job should originally be executed as a registered user job, the job is executed as the guest user's job.

Regarding processing of a job, for example, JP 2011-098515 A discloses an image forming apparatus “including: a user authentication means for identifying a user for using the image forming apparatus and limiting a function available to the user depending on the user; and a job execution result storage means for storing information of the authenticated user in information on an execution result of a job executed by the authenticated user, in which the user authentication means has a guest authentication function for making a specific function available without user authentication and the job execution result storage means stores the execution result as the job executed by a guest user when the job executed by the authenticated user is a job executable by the guest authentication function” (see [Abstract]).

Furthermore, other technologies related to the processing of the job are disclosed in, for example, JP 2009-214516 A and JP 2004-357017 A.

According to the technologies disclosed in JP 2011-0913515 A, JP 2009-214516 A, and JP 2004-357017 A, when a user transmits a guest user's job to a cloud print service or the like without performing an authentication process, the job is executed as the guest user's job even if the job should originally be executed as a registered user job. Thus, there is a need for a technology of replacing a guest user's job with a registered user's job and executing the job, as necessary.

### SUMMARY

The present disclosure has been made in view of the above background, and an object in one aspect is to provide a technology of replacing a guest user's job with a registered user's job and executing the job, as necessary.

To achieve the abovementioned object, according to an aspect of the present invention, an apparatus reflecting one aspect of the present invention comprises: a communicator that communicates with another apparatus; and a controller that processes a job, wherein the apparatus, further, is communicable with a storage that stores device identification information and user identification information in association with each other, and the controller acquires, from the other apparatus, an execution request for a guest user's job including the device identification information, acquires the device identification information from the execution request, accesses the storage to search for the user identification information associated with the device identification information, and processes the guest user's job as a registered user's job on the basis of a fact that the user identification information associated with the device identification information is acquired from the storage.

### BRIEF DESCRIPTION OF THE DRAWINGS

The above and other objects, features, aspects and advantages provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of an apparatus according to an embodiment;

FIG. 2 is a diagram illustrating an example of data included in a user management database (DB);

FIG. 3 is a diagram illustrating an example of data included in an asset management DB;

FIG. 4 is a diagram illustrating an example of data included in an external user management DB;

FIG. 5 is a diagram illustrating an example of a hardware configuration of an information processing device constituting the apparatus;

FIG. 6 is a diagram illustrating an example of a communication sequence of components of the apparatus;

FIG. 7 is a diagram illustrating a first example of internal processing of the apparatus;

FIG. 8 is a diagram illustrating a second example of the internal processing of the apparatus; and

FIG. 9 is a diagram illustrating a third example of the internal processing of the apparatus.

### DETAILED DESCRIPTION OF EMBODIMENTS

Hereinafter, one or more embodiments of the present invention will be described with reference to the drawings. However, the scope of the invention is not limited to the disclosed embodiments. In the following description, the same components are denoted by the same reference numerals. The names and functions thereof are also the same. Thus, detailed description thereof will not be repeated.

<A. System Overview>

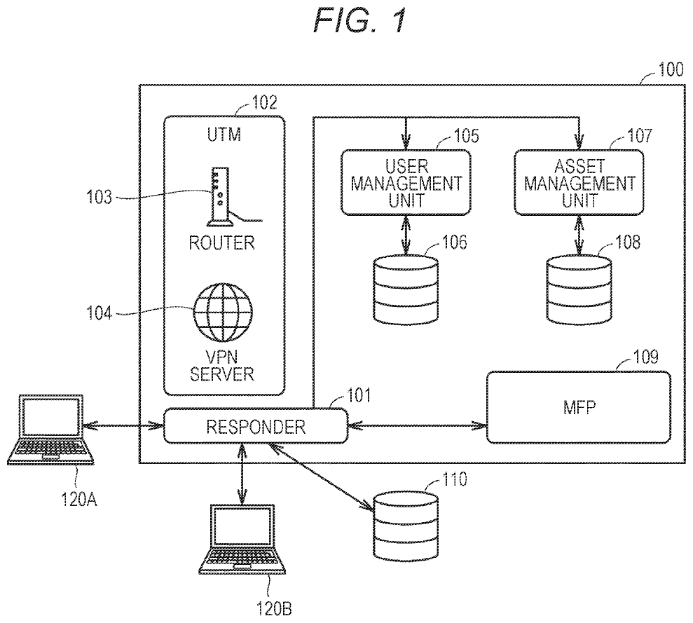

FIG. 1 is a diagram illustrating an example of an apparatus 100 according to the present embodiment. The apparatus 100 can provide a function (a cloud print service function or the like) of receiving a job execution request from a remote terminal and causing an MFP to execute, job included in the execution request. Furthermore, when an execution request for a guest user's job without authentication information is received from a remote terminal, the apparatus 101) can replace the guest user's job with a registered user's job that, is a job after an authentication process, as necessary, to cause the MFP to execute the job. In one aspect, the apparatus 100 may be implemented as one apparatus or a system including a plurality of apparatuses. Note that, the “execution request” is a message including a job, and can be implemented by, for example, a packet or the like transmitted by any protocol such as transmission control protocol (TCP)/IP.

Hereinafter, with reference to FIG. 1, a description will be given of an application example of the apparatus 100, a configuration of the apparatus 100, a type of a job included in an execution request that can be received by the apparatus 100, a problem caused by the type of the job, and a function of replacing a guest user's job of the apparatus 100 with a registered user's job.

(a. Application Example of System)

The apparatus 100 can receive a job execution request from a terminal 120 of a user, and on the basis of a job included in the execution request, can cause any apparatus including an MFP or the like to execute a job. As an example, the apparatus 100 can function as a cloud print service or server. Hereinafter, the apparatus 100 will be described using a print service as an example; however, an application of the apparatus 100 is not limited thereto. In one aspect, the apparatus 100 can function as a server of any service that receives a job execution request from a terminal of a user. In another aspect, the apparatus 100 can be built on a PC, a workstation, a server, or a cloud environment, and implemented as a virtual machine.

(b. Configuration of System)

The apparatus 100 includes a responder 101, a unified threat management (UTM) 102, a user management unit 105, a user management DB 106, an asset management unit 107, an asset management DB 108, and an MFP 109. The UTM 102 includes a router 103 and a VPN server 104. In one aspect, the MFP 109 may be an external MFP cooperating with the apparatus 100. The responder 101 can communicate with an external user management DB 110. The terminal 120 is a computer or the like operated by a user. In the example illustrated in FIG. 1, terminals 120A and 120B (which are collectively referred to as “terminal 120”) communicates with the apparatus 100. The terminal 120A is assumed to be connected to the apparatus 100 via a wide area network. Furthermore, it is assumed that the terminal POB is connected to the apparatus 100 via a local area network (LAN).

The responder 101 functions as a communication interface of the apparatus 100. The responder 101 communicates with for example, the terminal 120 of the user and the MFP 109. The responder 101 can communicate with any devices, such as a device using the apparatus 100, a device cooperating with the apparatus 100, and/or a device that acquires and executes a command from the apparatus 100. Moreover, the responder 101 can cooperate also with the UTM 102, the user management unit 105, and the asset management unit 107 included in the apparatus 100. The responder 101 can transfer access received from these devices, function in units, software, or the like to appropriate devices, functional units, software, or the like.

Furthermore, the responder 101 can receive a job execution request to the MFP 109 or the like. For example, the responder 101 can transfer, to the MFP 109, a job execution request received from the terminal 120E in the LAN, or a job execution request received from the terminal 120A on the wide area network side via a VPN. Furthermore, the responder 101 receives an access request to a web page for providing or setting a function of the apparatus 100 or the MFP 109. The responder 101 transmits the web page or a uniform resource locator (URL) of the web page to the terminal 120 that is a transmission source of the access request on the basis of the fact that the access request is received.

The UTM 102 can provide an integrated security function to protect a network and the like in an office. For example, the apparatus 100 can be connected to the wide area network and the LAN of the office. In this case, the UTM 102 can protect a device connected to the LAN from external threats with the security function. In one aspect, the UTM 102 can provide functions such as a firewall, anti-virus, anti-spam, URL filtering, application usage restrictions, VPN. Intrusion Prevention System (IPS), intrusion Detection System (IDS), and the like. The UTM 102 can include at least the router 103 and the VPN server 104.

In one aspect, when a VPN login process is executed, the UTM 102 may hold an IP address assigned to the terminal 120 and user identification information acquired at the time of the login process in association with each other. In that case, on the basis of the fact that an acquisition request for the user identification information associated with the IP address is received from the responder 101, the UTM 102 can return, to the responder 101, the user identification information associated with the IP address included in the acquisition request. The IP address can be used as device identification information described later. In another aspect, when the VPN login process is executed, the UTM 102 may transmit the IP address assigned to the terminal 120 and the user identification information acquired at the time of the login process to the asset management unit 107. In that case, the asset management unit 107 stores, in the asset management DB 108, the received IP address and the user identification information in association with each other.

The router 103 has, for example, an IP address assignment to a terminal on the LAN side, packet forwarding, port opening and closing, and packet filtering functions, a dynamic host configuration protocol (DHCP) server function, and the like. Moreover, in one aspect, the router 103 can provide a Wireless Fidelity (Wi-Fi) (registered trademark) function in a network on the LAN side. For example, the router 103 can provide a Wi-Fi access function for an employee (registered user) and a Wi-Fi access function for a visitor (guest user) in an office.

The VPN server 104 provides, for example, the terminal 120A on the wide area network side with a function of communicating with devices in the LAN via the VPN. By using the VPN, the terminal 120A and the devices in the LAN can implement secure communication via encrypted packets. In one aspect, the apparatus 100 may provide VPN software to the terminal 120A. In that case, for example, the apparatus 100 may have a web server function and a web page for downloading VPN software.

The user management unit 105 manages information regarding a user. Here, the user is, for example, a user of a device included in the apparatus 100, a device cooperating with the apparatus 100, and/or a device that acquires and executes a command from the apparatus 100. The user management unit 105 can execute a process of searching, adding, updating, or deleting data for the user management DB 106.

The user management DB 106 stores user information. The user information includes user identification information and various types of information associated with the user identification information. The various types of information can include, for example, a name, a contact address, an affiliation group, and the like of the user. In one aspect, the user management DB 106 may be in an external server for the apparatus 100, or a cloud environment. In that case, the user management unit 105 can access the user management DB 106 existing outside to execute the process of searching, adding, updating, or deleting data for the user management DB 106.

The asset management unit 107 manages asset information. An asset is, for example, a hardware resource, a software resource, and/or a service use license that can be provided by the apparatus 100 to the user. Furthermore, information on a device used by lite user can also be managed. For example, the asset management unit 107 can manage which user holds which terminal 120. In the example illustrated in FIG. 1, the terminal 120 and the MFP 109 correspond to hardware resources. Furthermore, when the apparatus 100 provides a web application or the like to the user, the web application corresponds to a software resource. The asset management unit 107 can execute a process of searching, adding, updating, and deleting data for the asset management DB 108.

In one aspect, on the basis of the fact that login of the user to the apparatus 100, VPN login, a plurality of times of communication to the apparatus 100 by the same terminal 120, or the like occurs, the asset management unit 107 may acquire device identification information and/or user identification information of the terminal 120 from the responder 101, the UTM 102, or the like, and store, in the asset management DB 108, the device identification information and the user identification information in association with each other.

The asset management DB 108 stores asset information. The asset information includes asset identification information and various types of information associated with the asset identification information. The various types of information are, for example, pieces of device identification information of devices (terminal 120, MFP 109, and the like) managed by the apparatus 100. The asset information can further include user identification information associated with the device identification information. The association between the device identification information and the user identification information indicates, for example, which user owns which terminal 120. In one aspect, the asset management DB 108 may be in an external server for the apparatus 100, or a cloud environment. In that case, the asset management unit 107 can access the asset management DB 108 existing outside, and execute the process of searching, adding, updating, and deleting data for the asset management DB 108.

The MFP 109 has a printer function, a copy function, and/or a scan function. Furthermore, the MFP 109 can receive job execution requests for these functions via a network such as the LAN. In the example illustrated in FIG. 1, the MFP 109 receives job execution requests from the terminals 120A and 120B via the responder 101. In one aspect, the MFP 109 may be implemented as an image forming apparatus integrated with the apparatus 100. In another aspect, the MFP 109 may be used to cooperate with the apparatus 100.

The external user management DB 110 is a DB managed by some system other than the apparatus 100. For example, the external user management DB 110 may be a DB of an internal system of a certain company. The responder 101 can acquire, from the external user management DB 110, information for uniquely identifying the user, device identification information on the terminal 120 used by the user, information on an affiliation group of the user, information on authority of the user, information on a login state and/or record of the user. These pieces of information can be used to register information of a user not registered in the apparatus 100 in the user management DB 106 and/or the asset management DB 108.

The terminal 120 is a PC, a tablet, a smartphone, or any information processing device used by the user. The terminal 120 can transmit a job execution request for the MFP 109 or the like to the apparatus 100. The terminal 120 can access the apparatus 100 mainly through two paths.

A first path is a path including the wide area network. For example, when the user needs to access functions provided by the apparatus 100 while working at home, the user can connect one's own terminal 120 with the apparatus 100 via the wide area network. Since the first path is a path with relatively low safety such as the wide area network, the user can use the VPN or the like. In the example illustrated in FIG. 1, the terminal 120A performs VPN communication with the apparatus 100 via the wide area network.

A second path is access from a specific domain For example, the user can connect one's own terminal 120 with the apparatus 100 by using a LAN cable or an access point of an in-house LAN of a company in which the apparatus 100 is installed. Since the second path is protected from an external (wide area network side) attack by the UTM 102 or the like, the second path is a path with relatively high safety. In the example illustrated in FIG. 1, the terminal 120B communicates with the apparatus 100 via the in-house LAN.

(c. Type of Job Included in Execution Request Received by Apparatus 100)

Next, the type of the job included in the execution request received by the apparatus 100 will be described using the print function provided by the apparatus 100 as an example. The execution request can include two types of jobs. A first job is a “registered user's job”. The MFP 109 has an authentication function. For example, when a job execution request including authentication information is received, the MFP 109 processes the job as the registered user's job. In one aspect, the MFP 109 can determine that a job to be executed next is the registered user's job on the basis of the fact that authentication information or a job execution command accompanied by the authentication information is input from an input device provided in the MFP 109. In another aspect, the MFP 109 can determine that a job to be executed next is the registered user's job on the basis of the fact that authentication information or a job execution request accompanied by the authentication information is received from the responder 101.

A second job is a “guest user's job”. The MFP 109 processes a user's job on which the authentication process is not performed, as the guest user's job. In one aspect, the MFP 109 can determine that a job to be executed next is the guest user's job on the basis of the fact that a job execution command is input from an input device provided in the MFP 109 without input of authentication information. In another aspect, the MFP 109 can determine that a job to be executed next is the guest user's job on the basis of the fact that a job execution request not accompanied by authentication information is received from the responder 101.

In one aspect, the authentication information can include a user name and a password, user's biometric information, data stored in an integrated circuit (IC) card, a smartphone, or the like, information by which any other user can be identified, or a combination thereof.

The MFP 109 has a function that can be used only by a registered user depending on a selling. For that reason, operation of the MFP 109 is different between a case where an execution request for the registered user's job is received and a case where an execution request for the guest user's job is received. For example, when the job included in the job execution request received by the MFP 109 is a guest user's job, the MFP 109 does not execute the “function that can be used only by the registered user” even if the job includes the setting of the “function that can be used only by the registered user”. That is, the MFP 109 does not execute a function for which an account transmitting the job execution request does not have use authority.

For example, it is assumed that the MFP 109 is set so that only the registered user can use a “full-color printing function”. Then, it is assumed that the MFP 109 receives an execution request for the guest user's job including a setting of the “full-color printing function”. In this case, the MFP 109 executes monochrome printing instead of executing full-color printing. For that reason, when the user needs to use a function that can be used only by the registered user, the user needs to transmit an execution request for the registered user's job from the terminal 120 to the MFP 109.

(d. Problems Caused by Guest User's Job)

Next, a description will be given of a problem that can occur when the apparatus 100 receives an execution request for the guest user's job. It is assumed that the apparatus 100 is used in a certain company and provides a cloud print service to employees. A user A who is an employee of the company and is working at ironic can transmit the execution request for the guest user's job to the responder 101 via the terminal 120A. At this time, when the responder 101 transfers the guest user's job to the MFP 109 as it is without using the function of replacing the guest user's job included in the execution request with the registered user's job, as an example, the following problem can occur.

A first problem is that a document with high confidentiality is viewed by others. When a user prints the document with high confidentiality that is only disclosed to a specific user by using the MFP 109, the user can use a “function of requesting password input at the time of outputting printed matter”. By the “function of requesting password input at the time of outputting printed matter”, the MFP 109 requests input of a password (such as a password of a user transmitting the job execution request) at the time of performing printing. By using the function of requesting password input at the time of outputting printed matter, the user can prevent the document with high confidentiality from being viewed by others.

In a case where the “function of requesting password input at the time of outputting printed matter” is registered in the MFP 109 as a function that can be used only by the registered user, when the responder 101 receives data of the document with high confidentiality and an execution request for the guest user's job including a setting of the “function of requesting password input at the time of outputting printed matter”, the MFP 109 prints the data of the document with high confidentiality without using the “function of requesting password input at the time of outputting printed matter”. For that reason, when the user A working at home forgets to perform the authentication process and transmits, to the responder 101, the execution request for the guest user's job including the data of the document with high confidentiality and the setting of the “function of requesting password input at the time of outputting printed matter”, the MFP 109 immediately prints the document without requesting password input. As a result, the user A working at home cannot immediately collect the printed document, and there is a possibility that the document with high confidentiality is viewed by others.

A second problem is that specific functions such as full-color printing cannot be used. In a case where the “full-color printing function” is registered in the MFP 109 as a function that can be used only by the registered user, when the responder 101 receives an execution request for the guest user's job including a setting of the “full-color printing function”, the MFP 109 performs monochrome printing of document data included in the job. For example, when the user working at home forgets to perform the authentication process and transmits a job execution request including the setting of the “full-color printing function” to the responder 101, the MFP 109 performs monochrome printing of the data of the document included in the job.

A third problem is that the number of jobs executed for each department cannot be accurately counted. In some companies, running cost of the MFP 109 may be shared between departments depending on the number of prints or the like for each department. In order for the responder 101 to count the number of jobs executed for each department, the job included in the received execution request needs to be a registered user's job. On the basis of user identification information of the registered user, the responder 101 can acquire information or the like of a department associated with the user identification information from the user management DB 106 or the like. However, when the job included in the execution request received by the responder 101 is a guest user's job, the responder 101 cannot obtain the user identification information and thus cannot count the number of jobs executed for each department.

As described above, various problems can occur when the terminal 120 transmits the execution request for the guest user's job to the apparatus 100 despite the fact that an execution request for the registered user's job should be transmitted. Thus, on the basis of the fact that the execution request for the guest user's job is received, the responder 101 replaces the guest user's job included in the execution request with the registered user's job and processes the job, as much as possible. Note that, “processing” in the apparatus 100 includes processing a job in the apparatus 100 and transmitting a job execution request to another device (the MFP 109 or the like) to cause the other device to execute the job.

(e. Function of Replacing Guest User's Job with Registered User's Job)

Next, a description will be given of means by which the apparatus 100 replaces the guest user's job with the registered user's job. The apparatus 100 call replace the guest user's job with the registered user's job and process the job, by means described below, for example.

As a first means, the apparatus 100 can use device identification information and user identification information to replace the guest user's job with the registered user's job. As an example, the responder 101 acquires device identification information included in the received execution request for the guest user's job, and transmits the device identification information to the asset management unit 107.

The asset management unit 107 searches the asset management DB 108 for the user identification information associated with the device identification information. On the basis of the fact that there is the user identification information associated with the device identification information (on the basis of the fact that the user can be identified), the responder 101 replaces the guest user's job with the registered user's job and processes the job. For example, when the registered user's job is a job for the MFP 109, the responder 101 transmits an execution request for the registered user's job to the MFP 109.

As a second means, the apparatus 100 can use VPN connection information and user identification information to replace the guest user's job with the registered user's job. As an example, on the basis of the fact that the execution request for the guest user's job is received from the terminal 120, the responder 101 determines whether or not the execution request for the guest user's job is transmitted via the VPN and includes an IP address assigned to the terminal 120 that is a transmission source of the execution request for the guest user's job.

In one aspect, the UTM 102 or the VPN server 104 may hold the VPN connection information, the IP address assigned to the terminal 120, and user identification information of an owner of the terminal 120 to which the IP address is given. As an example, on the basis of the fact that a request for a VPN login process (authentication process) is received from the terminal 120, the UTM 102 or the VPN server 104 can hold the user identification information acquired at the time of the login process and the IP address assigned to the terminal 120 in association with each other. In this case, the responder 101 can acquire the user identification information associated with the IP address from the UTM 102.

In another aspect, on the basis of the fact that it is determined that the execution request for the guest user's job is transmitted via the VPN and includes the IP address assigned to the terminal 120 that is the transmission source of the execution request for the guest user's job, the responder 101 may transmit the IP address to the asset management unit 107 as the device identification information. The asset management unit 107 returns user identification information associated with the received IP address to the responder 101.

The subsequent processing procedure of the asset management unit 107 is similar to that of the first means. Compared with the first means, the second means can more securely replace the guest user's job with the registered user's job in that the terminal 120 is verified with a communication path (VPN) and an IP address assigned for VPN communication.

As a third means, the apparatus 100 can use domain information to replace the guest user's job with the registered user's job. As an example, the responder 101 acquires an IP address included in the received execution request for the guest user's job, and determines whether or not the IP address is included in a reliable domain (such as a domain used in an office of a company). At that time, the responder 101 may refer to domain information included in the user management DB 106.

On the basis of the fact that it is determined that the IP address included in the received execution request for the guest user's job is included in the reliable domain, the responder 101 acquires device identification information included in the received execution request for the guest user's job, and transmits the device identification information to the asset management unit 107.

The subsequent processing procedure of the asset management unit 107 is similar to that of the first means. Compared with the first means, the third means can more securely replace the guest user's job with the registered user's job in that the terminal 120 is verified by using the domain information.

As a fourth means, the apparatus 100 can use information with high confidentiality included in the job to replace the guest user's job with the registered user's job. As an example, the responder 101 determines whether or not the job included in the received execution request for the guest user's job includes information with high confidentiality.

In one aspect, the responder 101 may determine whether or not the guest user's job includes information with high confidentiality on the basis of a name, information on a stamp, a character indicating confidentiality, or the like of a file included in the guest user's job.

On the basis of the fact that it is determined that the guest user's job includes information with high confidentiality, the responder 101 acquires device identification information included in the received execution request for the guest user's job, and transmits the device identification information to the asset management unit 107.

The subsequent processing procedure of the asset management unit 107 is similar to that of the first means. The fourth means is different from the first means in that it is determined whether or not the guest user's job includes important information. By the fourth means, the apparatus 100 can prevent a document with high confidentiality from being viewed by others.

In one aspect, the device identification information may be a MAC address or an IP address. Furthermore, in another aspect, on the basis of the fact that the responder 101 receives a login request from the same device at a predetermined frequency, the asset management unit 107 can store, in the asset management DB 108, device identification information of the terminal 120 that is a transmission source of a login request and user identification information of a user who logs in, in association with each other.

Furthermore, in another aspect, on the basis of the fact that the device identification information included in the received execution request for the guest user's job does not exist in the asset management DB 110, the responder 101 may acquire user identification information associated with the device identification information from the external user management DB 108. On the basis of the fact that the user identification information associated with the device identification information can be acquired from the external user management DB 110, the responder 101 replaces the guest user's job with the registered user's job and processes the job.

The responder 101 can transfer various types of information acquired from the external user management DB 110 to the user management unit 105 and the asset management unit 107. The user management unit 105 can store the user identification information acquired from the external user management DB 110 and information related to the user identification information (user's name, affiliation group, and the like) in the user management DB 106. Furthermore, the asset management unit 107 can store, in the asset management DB 108, the user identification information acquired front the external user management DB 110 anti a device identifier included in the execution request for the guest user's job in association with each other.

In another aspect, when the guest user's job is replaced with the registered user's job, the responder 101 may transmit a notification of a replacement process for the job to the terminal 120 that is a transmission source of the execution request for the guest user's job. Moreover, in another aspect, on the basis of the fact that a permission notification of the replacement process is received from the terminal 120 that is the transmission source of the execution request for the guest user's job, the responder 101 may replace the guest user's job with the registered user's job, and transmit the replaced job to the MFP 109. Conversely, on the basis of the fact that a non-permission notification of the replacement process is received from the terminal 120 that is the transmission source of the execution request for the guest user's job, the responder 101 transmits the execution request for the guest user's job lo the MFP 109 as it is.

Moreover, in another aspect, the responder 101 may acquire, front the asset management DB 108 via the asset management unit 107, user identification info station of a user transmitting the guest user's job, information on an affiliation department of the user, and a job execution counter set for each department. In that case, on the basis of the fact that the job execution counter is set for each department, the responder 101 can update the job execution counter after execution of the registered user's job. Furthermore, the apparatus 100 can appropriately combine and execute the above first to fourth means.

<B. Data Used by System>

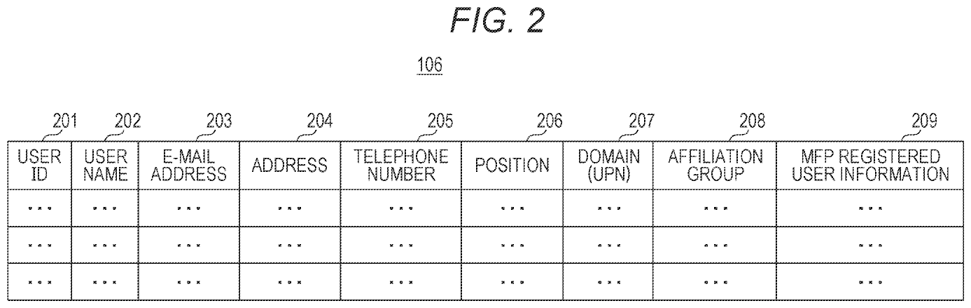

Next, data used by the apparatus 100 will be described with reference to FIGS. 2 to 4. FIG. 2 is a diagram illustrating an example of data included in the user management DB 106. The responder 101 can acquire user identification information of each user and its related information by referring to the user management DB 106 via the user management unit 105.

The user management DB 106 includes a user identifier (ID) 201, a user name 202, an e-mail address 203, an address 204, a telephone number 205, a position 206, a domain 207, an affiliation group 208, and MFP registered user information 209.

The user ID 201 uniquely identifies a user. In one aspect, the responder 101 may use the user ID 201 as the user identification information. The user name 202 is a name of the user. The e-mail address 203 is an e-mail address of the user. In one aspect, the user management DB 106 may include an ID or a contact address of the user in any application in addition to the e-mail address.

The address 204 is an address of the user. The telephone number 205 is a telephone number of the user. The position 206 is a position in an affiliation group of the user. In one aspect, when the guest user's job is replaced with the registered user's job and the job is processed, the responder 101 may limit execution authority of the job depending on the position 206 of the user.

The domain 207 is information regarding a domain used when the user logs in from an in-house LAN or the like. In one aspect, the responder 101 may use the domain 207 as a user principal name (UPN).

The affiliation group 208 is identification information and/or a name of a group (a department of a company or the like) to which the user belongs. In one aspect, the apparatus 100 may store a job execution counter of each group in the user management DB 106, the asset management DB 108, or another storage area. The apparatus 100 can update a value of the job execution counter of the group to which a registered user belongs each time the registered user's job is processed.

The MFP registered user information 209 is information of a user registered in the MFP 109. In one aspect, the MFP registered user information 209 may include a user name and, a password of the user registered in the MFP 109. In another aspect, the responder 101 may use the MFP registered user information 209 as the user identification information.

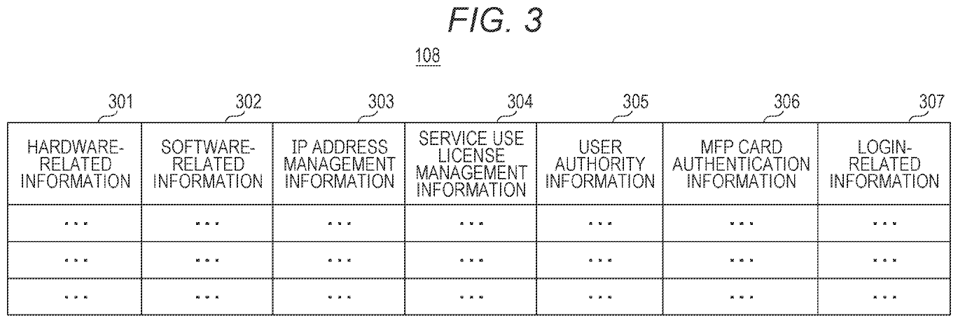

FIG. 3 is a diagram illustrating an example of data included in the asset management DB 108. The asset management DB 108 manages hardware resources and/or software resources managed by the apparatus 100. As an example, when a job execution request is received, the apparatus 100 can acquire user identification information associated with device identification information included in the execution request (call identify an owner of the terminal 120) by referring to the asset management DB 108.

The asset management DB 108 includes hardware-related information 301, software-related information 302, IP address management information 303, service use license management information 304, user authority information 305, MFP card authentication information 306, and to information 307.

The hardware-related information 301 includes information regarding hardware (the terminal 120, the MFP 109, and the like). In one aspect, the hardware-related information 301 can include information such as a name of hardware, a user identification information, a MAC address, an IP address, an expiration date, and/or an installation location. In one aspect, the hardware-related information 301 may include association information of user identification information (such as the user ID 201 and/or the MFP registered user information 209) and device identification information (such as the MAC address and/or the IP address). For example, the asset management unit 107 can determine an owner of each terminal 120 by referring to the association information.

The software-related information 302 includes information regarding software. In one aspect, the software-related information 302 can include a name of the software, user identification information, a URL, an IP address and/or an expiration date.

The IP address management information 303 includes information regarding an IP address managed by the apparatus 100. In one aspect, the IP address management information 303 can include a list of IP addresses, a list of devices or the terminals 120 (or the users who own the terminals 120) to which the IP addresses are assigned, locations of the devices or the terminals 120 to which the IP addresses are assigned, use start times of the assigned IP addresses, and the like.

In one aspect, the IP address management information 303 may include an IP address assigned by the VPN. In that case, the responder 101 can determine whether or not the terminal 120 in communication is performing VPN communication using the assigned IP address by referring to the asset management DB 108 via the asset management unit 107.

The service use license management information 304 includes license information and the like of a service managed by the apparatus 100. The service can include hardware managed by the hardware-related information 301 and/or software managed by the software-related information 302. In one aspect, the service use license management information 304 can include a service name, a remaining number of licenses of each service, information of a user of each service, an expiration date of each service, and the like.

The user authority information 305 includes authority information on functions of a service and/or device given to the user. In one aspect, the user authority information 305 can include use authority of a function of the MFP 109 for each user. In that case, when the guest user's job is replaced with the registered user's job and the job is processed, the responder 101 may limit the execution authority of the job depending on the authority of the user with reference to the user authority information 305. In one aspect, the user authority information 305 may be set on the basis of the position 206.

The MFP card authentication information 306 includes information indicating which user can log in to the MFP 109 with which ID card. The login-related information 307 includes a number of login attempts for the service and/or the device. In one aspect, the login-related information 307 may include user identification information and device identification information for each log in record. In that case, the responder 101 can acquire corresponding device identification information and user identification information from a history of a past login process (authentication process) by referring to the login-related information 307. Furthermore, the responder 101 can store the acquired user identification information in the user management DB 106 via the user management unit 105. Moreover, the responder 101 can store the acquired device identification information and user identification information in the asset management DB 108 via the asset management unit 107. In one aspect, when the same user has logged in to the apparatus 100 a plurality of times or at a certain frequency or more using the same terminal 120, the responder 101 may store, in the asset management DB 108, the user identification information of the user and the device identification information of the terminal 120 in association with each other.

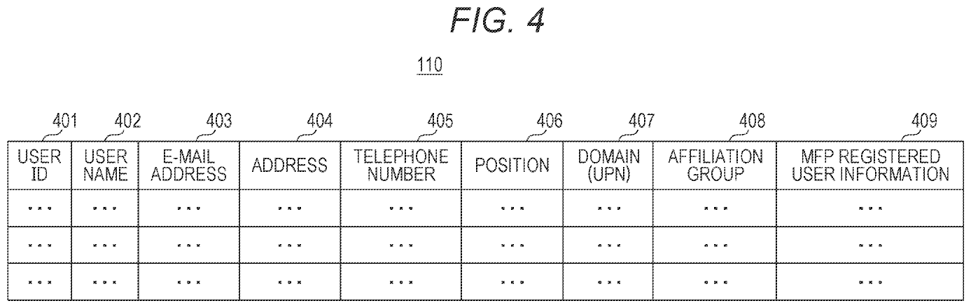

FIG. 4 is a diagram illustrating an example of data included in the external user management DB 110. When receiving an execution request for the guest user's job, the apparatus 100 searches the user management DB 106 for user identification information associated with device identification information included in the execution request. If the user identification information associated with the device identification information is not in the user management DB 106, the apparatus 100 can search the external user management DB 110 to acquire the user identification information associated with the device identification information. Moreover, the apparatus 100 can add the acquired device identification information and user identification information to the asset management DB 108.

The external user management DB 110 includes a user ID 401, a user name 402, an e-mail address 403, an address 404, a telephone number 405, a position 406, a domain 407, an affiliation group 408, and MFP registered user information 409. The user ID 401 to the MFP registered user information 409 correspond to the user ID 201 to the MFP registered user information 209 of the user management DB 106. In one aspect, the responder 101 may acquire information of a user not registered in the user management DB 106 from the external user management DB 110 in advance. In another aspect, the responder 101 may appropriately acquire the information of the user not registered in the user management DB 106 from the external user management DB 110 as necessary.

Note that, the external user management DB 110 does not necessarily have to include all the data included in the user management DB 106. In one aspect, the responder 101 may acquire a part of data to be stored in the user management DB 106 from the external user management DB 110, and acquire remaining data from another DB or device. For example, the responder 101 may acquire the MFP registered user information 209 from the MFP 109.

<C. Hardware Configuration>

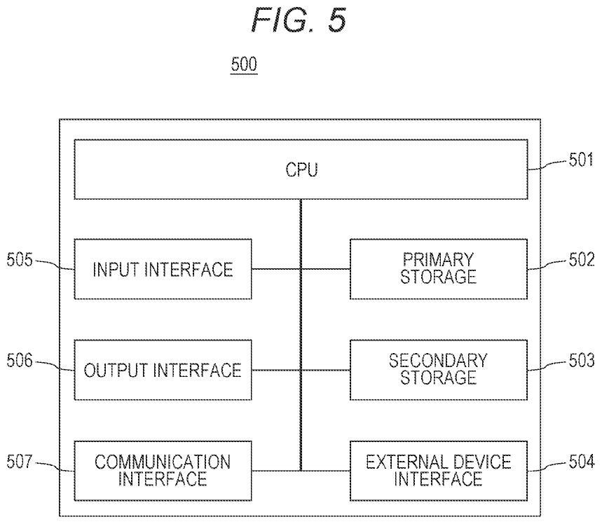

FIG. 5 is a diagram illustrating an example of a hardware configuration of an information processing device 500 constituting a portion other than the MFP 109 of the apparatus 100. The apparatus 100 can be implemented by one or more information processing devices 500. In one aspect, the apparatus 100 may be implemented as the MFP 109 incorporating the information processing device 500. Furthermore, components of the apparatus 100 illustrated in FIG. 1 can be implemented using hardware of the information processing device 500 or as software operating on the hardware of the information processing device 500.

The information processing device 500 includes a central processing unit (CPU) 501, a primary storage 502, a secondary storage 503, an external device interface 504, an input interface 505, an output interface 506, and a communication interface 507.

The CPU 501 can execute a program for implementing various functions of the information processing device 500. The CPU 501 includes, for example, at least one integrated circuit. The integrated circuit may include, for example, at least one CPU, at least one field programmable gate array (FPGA), or a combination thereof.

The primary storage 502 stores the programs executed by the CPU 501 and data referred to by the CPU 501. In one aspect, the primary storage 502 may be implemented by a dynamic random access memory (DRAM), a static random access memory (SRAM), or the like.

The secondary storage 503 is a nonvolatile memory, and may store the programs executed by the CPU 501 and the data referred to by the CPU 501. In that case, the CPU 501 executes the programs read from the secondary storage 503 to the primary storage 502, and refers to the data read from the secondary storage 503 to the primary storage 502. In one aspect, the secondary storage 503 may be implemented by a hard disk drive (HDD), a solid state drive (SSD), an erasable programmable read only memory (EPROM), an electrically erasable programmable read only memory (EEPROM), a flash memory, or the like.

The external device interface 504 can be connected to any external devices such as a printer, a scanner, and an external HDD. In one aspect, the external device interface 504 may be implemented by a universal serial bus (USB) terminal or the like.

The input interface 505 can be connected to any input device such as a keyboard, a mouse, a touchpad, or a game pad. In one aspect, the input interface 505 may be implemented by a USB terminal, a PS/2 terminal, a Bluetooth (registered trademark) module, and the like.

The output interface 506 can be connected to any output device such as a cathode ray tube display, a liquid cry staff display, or an organic electro-luminescence (EL) display. In one aspect, the output interface 506 may be implemented by a USB terminal, a D-sub terminal, a digital visual interface (DVI) terminal, a High-Definition Multimedia Interface (HDMI) (registered trademark) terminal, or the like.

The communication interface 507 is connected to a wired or wireless network device, in one aspect, the communication interface 507 may be implemented by a wired local area network (LAN) port, a Wireless Fidelity (Wi-Fi) (registered trademark) module, and the like. In another aspect, the communication interface 507 may transmit and receive data using a communication protocol such as TCP/IP or a user datagram protocol (UDP).

<D. System Communication and Internal Processing>

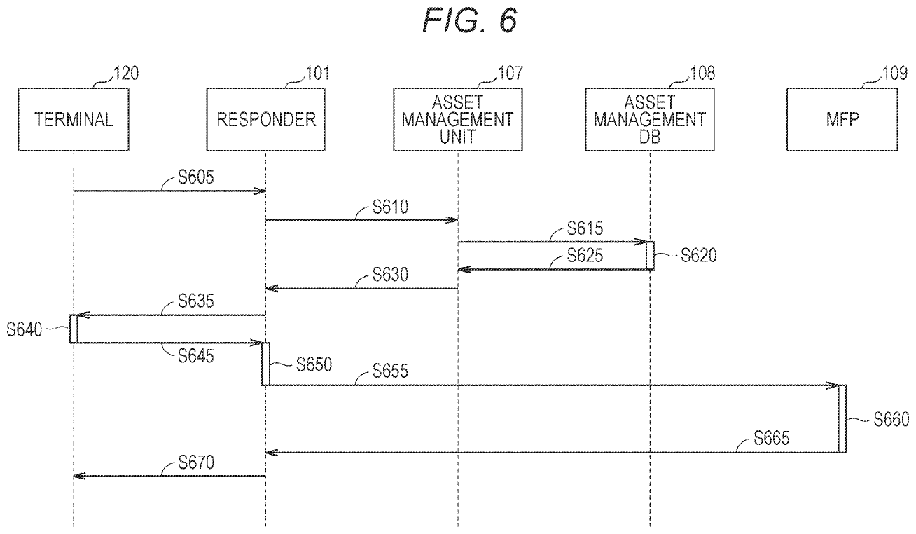

Next, communication between the components of the apparatus 100 and internal operation of the apparatus 100 will be described with reference to FIGS. 6 to 9. FIG. 6 is a diagram illustrating an example of a communication sequence of the components of the apparatus 100.

In step S605, the terminal 120 transmits an execution request for the guest user's job to the responder 101. The execution request can include, for example, a file to be printed, a setting for printing, user identification information (indicating either a registered user or a guest user), and device identification information (such as a MAC address and/or an IP address). Since the job included in the execution request transmitted in step S605 is a guest user's job, the user identification information indicates the guest user.

In step S610, the responder 101 transmits a search request for user identification information to the asset management unit 107. The search request for user identification information includes the device identification information. In step S615, the asset management unit 107 transmits the search request for user identification information to the asset management DB 108.

In step S620, the asset management DB 108 searches a table for a record including the device identification information acquired as a key. More specifically, a database management system that manages the asset management DB 108 searches the table of the asset management DB 108.

In step S625, the asset management DB 108 transmits found user identification information to the asset management unit 107. In step S630, the asset management unit 107 transmits the user identification information to the responder 101.

In step S635, the responder 101 transmits, to the terminal 120, a notification for confirming whether or not the guest user's job may be replaced with the registered user's job. In step S640, the terminal 120 receives an operation input regarding whether or not the job can be replaced. In step S645, the terminal 170 transmits, to the responder 101, a job replacement permission notification or a job replacement non-permission notification.

In step S650, the responder 101 replaces the guest user's job with the registered user's job when the job replacement permission notification is received. The responder 101 does not replace the guest user's job with the registered user's job when the job replacement non-permission notification is received.

In step S655, the responder 101 transmits a job execution request to the MFP 109. When the replacement process for the job is executed in step S650, the responder 101 transmits an execution request for the registered user's job to the MFP 109. In one aspect, when the apparatus 100 is integrated with the MFP 109, the responder 101 may transmit, to the MFP 109, only the job instead of the job execution request.

In step S660, the MFP 109 executes the job (document printing, or the like). In step S665, the MEP 109 transmits a job execution completion notification to the responder 101. In step S670, the responder 101 transmits the job execution completion notification to the terminal 120.

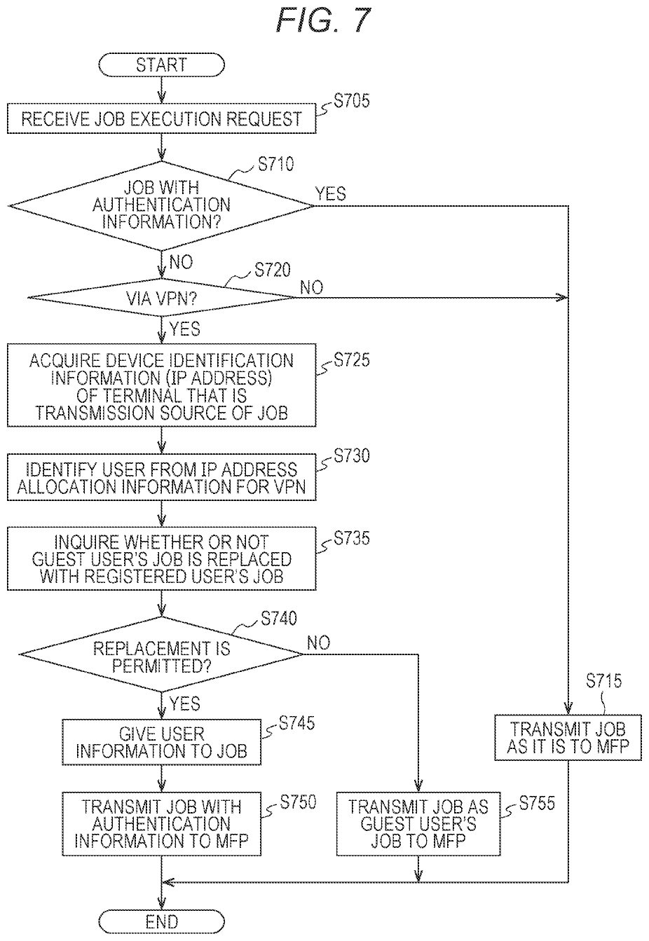

FIG. 7 is a diagram illustrating a first example of internal processing of the apparatus 100. In one aspect, the CPU 501 may read a program for performing processing of FIG. 7 from the secondary storage 503 into the primary storage 502 and execute the program. In another aspect, a part or all of the processing can be implemented as a combination of circuit elements formed to execute the processing.

In step S705, the responder 101 receives a job execution request from the terminal 120. In step S710, the responder 101 determines whether or not the job included in the received execution request is a job with authentication information (registered user's job). The authentication information includes information by which the user can be identified. In one aspect, the authentication information may include, for example, the MFP registered user information 209. In another aspect, the authentication information may include user identification information corresponding to the user ID 201. The responder 101, when it is determined that the job included in the received execution request is a job with authentication information (YES in step S710), shifts control to step S715. Otherwise (NO in step S710), the responder 101 shifts the control to step S720.

In step S715, the responder 101 transmits the job or the job execution request as it is to the MFP 109. In step S720, the responder 101 determines whether or not an execution request for the guest user's job is received via the VPN. The responder 101, when it is determined that the guest user's job execution request is received via the VPN (YES in step S720), shifts the control to step S725. Otherwise (NO in step S720), the responder 101 shifts the control to step S715.

In step S725, the responder 101 acquires device identification information (IP address) of the terminal 120 that is a transmission source of the job. In step S730, the responder 101 identifies the user from IP address assignment information for the VPN. In one aspect, the responder 101 may transmit an inquiry request for the IP address assignment information to the UTM 102. In this case, the UTM 102 may store, for example, the user identification information (the user ID 201 and the like) acquired from the terminal 120 at the time of the VPN authentication process in association with the IP address assigned to the terminal 120. Furthermore, the UTM 102 can transmit the user identification information associated with the IP address assigned to the terminal 120 to the responder 101 on the basis of the inquiry request for the IP address assignment information from the responder 101. In another aspect, the responder 101 may acquire the user identification information corresponding to the IP address assigned from the asset management DB 108 via the asset management unit 107.

In step S735, the responder 101 transmits, to the terminal 120, a notification for confirming whether or not the guest user's job may be replaced with the registered user's job. In step S740, the responder 101 determines whether or not a notification for permitting the replacement process for the job is received from the terminal 120. The responder 101, when it is determined that the notification for permitting the replacement process for the job is received from the terminal 120 (YES in step S740), shifts the control to step S745. Otherwise (NO in step S740), the responder 101 shifts the control to step S755.

In step S745, the responder 101 gives user information (authentication information for the MFP 109) to the guest user's job, and replaces the job with the registered user's job. In step S750, the responder 101 transmits the job with authentication information (registered user's job) to the MFP 109. In step S755, the responder 101 transmits the guest user's job to the MFP 109.

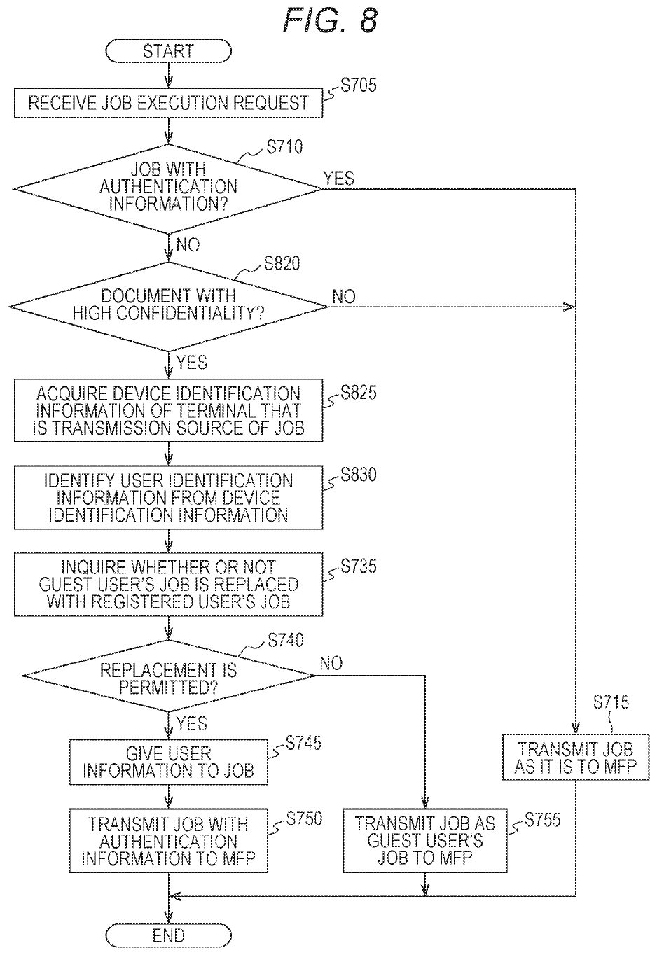

FIG. 8 is a diagram illustrating a second example of the internal processing of the apparatus 100. In one aspect, the CPU 501 may read a program for performing processing of FIG. 8 from the secondary storage 503 into the primary storage 502 and execute the program. In another aspect, a part or all of the processing can be implemented as a combination of circuit elements formed to execute the processing. Among processes illustrated in FIG. 8, the same processes as processes illustrated in 7 are denoted by the same step numbers. Thus, description of the same process is not repeated.

In step S820, the responder 101 determines whether or not the guest user's job included in the received execution request includes a document with high confidentiality. In one aspect, the responder 101 can determine that the guest user's job includes the document with high confidentiality on the basis of a name, information on a stamp, a character indicating confidentiality, or the like of a file included in the guest user's job.

The responder 101, when it is determined that the guest user's job included in the received execution request includes the document with high confidentiality (YES in step S820), shifts the control to step S825. Otherwise (NO in step S820), the responder 101 shifts the control to step S715.

In step S825, the responder 101 acquires device identification information included in the execution request for the guest user's job. In one aspect, the device identification information may include a MAC address and/or an IP address.

In step S830, the responder 101 inquires of the asset management unit 107 about user identification information associated with the acquired device identification information. The asset management unit 107 can return, as the user identification information, user identification information (such as the user ID 201 and/or the MFP registered user information 209) associated with the device identification information in the hardware-related information 301.

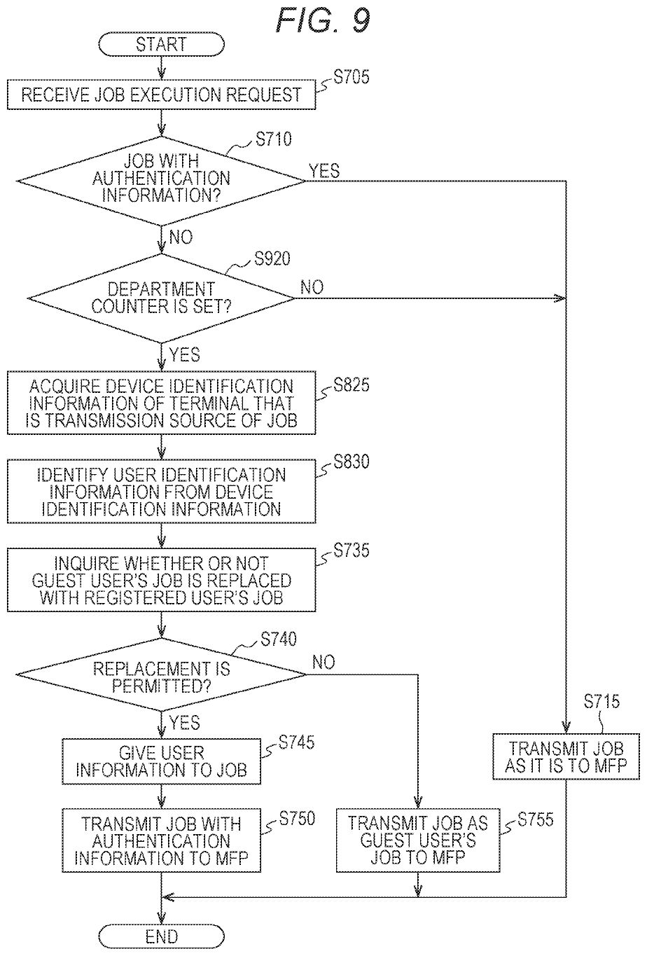

FIG. 9 is a diagram illustrating a third example of the internal processing of the apparatus 100. In one aspect, the CPU 501 may read a program for performing processing of FIG. 9 from the secondary storage 503 into the primary storage 502 and execute the program. In another aspect, a part or all of the processing can be implemented as a combination of circuit elements formed to execute the processing. Among processes illustrated in FIG. 9, the same processes as the processes illustrated in FIG. 7 or FIG. 8 are denoted by the same step numbers. Thus, description of the same process is not repeated.

In step S920, the responder 101 determines whether or not a department counter is set in the apparatus 100. In one aspect, the department counter may be included in the hardware-related information 301. In that case, the responder 101 can acquire information on the department counter via, the asset management unit 107. The responder 101, when it is determined that the department counter is set in the apparatus 100 (YES in step S920), shifts the control to step S825. Otherwise (NO in step S920), the responder 101 shifts the control to step S715.

As described above, the apparatus 100 according to the present embodiment has a function of replacing a guest user's job with a registered user's job and processing the job, on the basis of the fact that an execution request for the guest user's job is received. With the function, even when the user transmits the job execution request to the apparatus 100 in a state where the user forgets to perform the authentication process, the apparatus 100 can replace the guest user's job with the registered user's job as necessary and cause the MFP 109 to execute a function that can be used only by the registered user. As a result, even when the user transmits the job to the apparatus 100 in a state where the user forgets to perform the authentication process, it is possible to suppress occurrence of problems such as that a document with high confidentiality is viewed by others, that functions such as full-color printing cannot be used, and that the execution counter of the job cannot be updated.

Although embodiments of the present invention have been described and illustrated in detail, the disclosed embodiments are made for purposes of illustration and example only and not limitation. The scope of the present invention should be interpreted by terms of the appended claims. Furthermore, the disclosed content described in the embodiment and each modification is intended to be implemented alone or in combination, as far as possible.

What is claimed is:

1. An apparatus comprising:
a communicator that communicates with another apparatus; and
a controller that processes a job, wherein
the apparatus, further, is communicable with a storage that stores device identification information and user identification information in association with each other, and
the controller
acquires, from the other apparatus, an execution request for a guest user's job including the device identification information,
acquires the device identification information from the execution request,
accesses the storage to search for the user identification information associated with the device identification information, and
processes the guest user's job as a registered user's job on the basis of a fact that the user identification information associated with the device identification information is acquired from the storage.

2. The apparatus according to claim 1, further comprising
a virtual private network (VPN) processor that assigns an internet protocol (IP) address of a VPN to another device, wherein
the VPN processor
receives a request for an authentication process including the user identification information from the other device,
assigns the IP address of the VPN to the other device after the authentication process, and
stores the user identification information in the storage, and
the controller
acquires the user identification information corresponding to the IP address from the VPN processor on the basis of a fact that a request for the job is transmitted via the VPN and includes the IP address assigned by the VPN processor, and
processes the guest user's job as the registered user's job on the basis of a fact that the user identification information is acquired.

3. The apparatus according to claim 1, wherein
the storage further stores information regarding a domain, and
the processing of the guest user's job as the registered user's job includes accessing the storage to search for the user identification information associated with the device identification information on the basis of a fact that an IP address included in an execution request for the guest user's job belongs to the domain.

4. The apparatus according to claim 1, wherein the processing of the guest user's job as the registered user's job includes accessing the storage to search for the user identification information associated with the device identification information on the basis of a fact that the guest user's job includes information with high confidentiality.

5. The apparatus according to claim 4, wherein the controller further determines whether or not the guest user's job includes the information with high confidentiality on the basis of a name, information on a stamp, or a character indicating confidentiality of a file included in the guest user's job.

6. The apparatus according to claim 1, wherein
the storage further stores each of a plurality of pieces of the user identification information, information on an affiliation group of each of a plurality of the registered users, and a job execution counter for each of a plurality of the affiliation groups, and
the controller updates a value of the job execution counter after execution of the registered user's job on the basis of a fact that the job execution counter is set for each affiliation group.

7. The apparatus according to claim 1, wherein the device identification information is a media access control (MAC) address or an IP address.

8. The apparatus according to claim 1, wherein the processing of the guest user's job as the registered user's job includes transmitting a notification of a replacement process for the job to an apparatus that is a transmission source of an execution request for the guest user's job on the basis of the fact that the user identification information associated with the device identification information is acquired.

9. The apparatus according to claim 8, wherein the processing of the guest user's job as the registered user's job includes processing the guest user's job as the registered user's job on the basis of a fact that a permission notification of the replacement process is received from the apparatus that is the transmission source.

10. The apparatus according to claim 1, wherein the controller further stores, in the storage, the device identification information and the user identification information included in a login request in association with each other, on the basis of a fact that the login request is received a plurality of times front an identical device.

11. The apparatus according to claim 1, wherein
the controller further
requests the user identification information associated with the device identification information from an external user management system via the communicator on the basis of a fact that the device identification information included in the execution request for the guest user's job is not stored in the storage, and
processes the guest user's job as the registered user's job on the basis of a fact that the user identification information is acquired from the user management system.

12. A method of processing a job executed by an apparatus, the method comprising:
acquiring, from another apparatus, an execution request for a guest user's job including device identification information;
acquiring the device identification information from the execution request;
acquiring user identification information associated with the device identification information; and
processing the guest user's job as a registered user's job on the basis of a fact that the user identification information associated with the device identification information is acquired.

13. The method according to claim 12, further comprising:
receiving a request for an authentication process including the user identification information from another device;
assigning an IP address of a VPN to the other device after the authentication process;
storing the user identification information;
identifying the user identification information co responding to the IP address on the basis of a fact that a request for the job is transmitted via the VPN and includes the IP address assigned; and
processing the guest user's job as the registered user's job on the basis of a fact that the user identification information is identified.

14. The method according to claim 12, further comprising
storing information regarding a domain wherein
the processing of the guest user's job as the registered user's job includes searching for the user identification information associated with the device identification information on the basis of a fact that an IP address included in an execution request for the guest user's job belongs to the domain.

15. The method according to claim 12, wherein the processing of the guest user's job as the registereduser's job includes searching for the user identification information associated with the device identification information on the basis of a fact that the guest user's job includes information with high confidentiality.

16. The method according to claim 15, further comprising determining whether or not the guest user's job includes the information with high confidentiality on the basis of a name, information on a stamp, or a character indicating confidentiality of a file included in the guest user's job.

17. The method according to claim 12, further comprising:
storing each of a plurality of pieces of the user identification information, information on an affiliation group of each of a plurality of the registered users, and a job execution counter for each of a plurality of the affiliation groups; and
updating a value of the job execution counter after execution of the registered user's job on the basis of a fact that the job execution counter is set for each affiliation group.

18. The method according to claim 12, wherein the device identification information is a MAC address or an IP address.

19. The method according to claim 12, wherein the processing of the guest user's job as the registered user's job includes transmitting a notification of a replacement process for the job to an apparatus that is a transmission source of an execution request for the guest user's job on the basis of the fact that the user identification information associated with the device identification information is acquired.

20. A non-transitory recording medium storing a computer readable program for causing one or a plurality of processors to execute the method according to claim 12.
